(19) United States
(12) Patent Application Publication
(10) Pub. No.: US 2008/0187407 A1
(43) Pub. Date: Aug. 7, 2008

(54) FASTENING STRUCTURE FOR REDUCING SURFACE TEMPERATURE OF HOUSING

(75) Inventors: Chi-Wei Tien, Taipei City (TW); Hsuan-Cheng Wang, Taipei City (TW); Wei-Chung Hsiao, Taipei City (TW); Chih-Yung Kao, Taipei City (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, omitted

(73) Assignee: COMPAL ELECTRONICS, INC., Taipei City (TW)

(21) Appl. No.: 11/944,454

(22) Filed: Nov. 22, 2007

(30) Foreign Application Priority Data
Feb. 2, 2007 (TW) 96103855

(51) Int. Cl. F16B 39/01

(52) U.S. Cl. 411/107

(57) ABSTRACT

A fastening structure including a first housing, a substrate, a second housing, and a fastening component is provided. The first housing has a first boss with a first opening, and a sidewall of the first opening is made of metal. The substrate has a second opening. The second housing has a second boss with a third opening. One end of the fastening component passes through the third opening and is fastened in the first opening, and the other end of the fastening component is restricted in one end of the third opening to fasten the substrate between the first housing and the second housing. Both the metal sidewall and the sidewall of the fastening component therein do not contact the substrate.

### CROSS-REFERENCE TO RELATED APPLICATION

This application claims the priority benefit of Taiwan application serial no. 96103855, filed Feb. 2, 2007. All disclosure of the Taiwan application is incorporated herein by reference.

### BACKGROUND OF THE INVENTION

1. Field of the Invention

The present invention relates to a fastening structure. More particularly, the present invention relates to a fastening structure for reducing a surface temperature of housing.

2. Description of Related Art

Recently, as the rapid development of electronic science and technology, the operating frequency of an electronic device is increased, and the heat generation power of electronic components inside the electronic device is raised continuously. Taking notebook for example, the interior of the host of the notebook is just like a heat generation source, which continuously emits heat. Especially when the user is operating the notebook, as both hands should rest on the host of the notebook to input characters through the keyboard, and the hands are only isolated from the heat generation source inside the host by the case, so that the user has the most direct feeling about the temperature difference caused by the heat of the host.

FIG. 1 is a schematic view of a fastening structure in a conventional notebook. Referring to FIG. 1, the conventional fastening structure 100 includes a first housing 110, a substrate 120, a second housing 130, and a fastening component 140. The first housing 110 has a first boss 112 with a first opening 112a, and the sidewall 112b of the first opening 112a is made of metal, for providing the strength for fastening the fastening component 140. The substrate 120 has a second opening 122. The second housing 130 has a second boss 132 with a third opening 132a.

The substrate 120 is located between the first housing 110 and the second housing 130. One end of the fastening component 140 passes through the third opening 132 of the second housing 130 and the second opening 122 of the substrate 120, and is fastened to the sidewall 112b of the first opening 112a of the first housing 110. As such, the substrate 120 is clamped by the first boss 112 and the second boss 132 and restricted there-between, so as to make the metal sidewall 112b contact the substrate 120.

After the user operates the notebook for a while, the heat generated by the electronic components (not shown) is conducted to the substrate 120. As the metal sidewall 112b has a low thermal resistance, the heat conducted to the substrate 120 is rapidly transferred from the sidewall 112b to the first housing 110. As a result, the heat is continuously accumulated on the first housing 110 to make the temperature of the first housing 110 raise rapidly. When the hands of the user contact or rest on the first housing 110, the user may feel uncomfortable upon the rapid-rising temperature, and thus causing discomfort in operation.

### SUMMARY OF THE INVENTION

The present invention is directed to a fastening structure, for reducing the surface temperature of housing.

The fastening structure of the present invention includes a first housing, a substrate, a second housing, and a fastening component. The first housing has a first boss with a first opening, and a sidewall of the first opening is made of metal. The substrate has a second opening. The second housing has a second boss with a third opening. One end of the fastening component passes through the third opening and is fastened in the first opening, and the other end of the fastening component is restricted in one end of the third opening, so as to fasten the substrate between the first housing and the second housing. Both the metal sidewall and the sidewall of the fastening component therein do not contact the substrate.

In an embodiment of the present invention, the outer diameter of the other end of the fastening component is larger than the inner diameter of the third opening.

In an embodiment of the present invention, the fastening component is a screw.

In an embodiment of the present invention, the first opening, the second opening, and the third opening are coaxial.

In an embodiment of the present invention, one end of the fastening component further passes through the second opening and is fastened in the first opening.

In an embodiment of the present invention, the fastening structure further includes an elastic pad, which is clamped between the first boss and the substrate, and has a thermal conductivity smaller than that of the metal.

In an embodiment of the present invention, the fastening structure further includes an elastic pad, which is clamped between the second boss and the substrate, and has a thermal conductivity smaller than that of the metal.

In an embodiment of the present invention, the fastening structure further includes an elastic pad, which is clamped between the first housing and the substrate, and has a thermal conductivity smaller than that of the metal.

In an embodiment of the present invention, the fastening structure further includes an elastic pad, which is clamped between the second housing and the substrate, and has a thermal conductivity smaller than that of the metal.

In an embodiment of the present invention, the fastening structure further includes a sleeve, which is located between the sidewall of the fastening component and the second opening of the substrate.

In an embodiment of the present invention, the fastening structure further includes a sleeve, with one end passing through the third opening and the second opening, in which one end of the fastening component passes through the sleeve and is fastened in the first opening.

In an embodiment of the present invention, the sleeve restricts the depth for one end of the fastening component in the first opening.

In an embodiment of the present invention, the outer diameter of the other end of the sleeve is larger than the inner diameter of the third opening.

In an embodiment of the present invention, the fastening component has a first section and a second section. When the end of the fastening component passes through the third opening and fastens in the first opening, the first section is fastened in the first opening, and the other end of the fastening component is restricted in one end of the third opening, so as to fasten the substrate between the first housing and the second housing.

In an embodiment of the present invention, the outer diameter of the first section is smaller than that of the second section.

In an embodiment of the present invention, one end of the first boss contacts the substrate.

In an embodiment of the present invention, one end of the first boss passes through the second opening, and contacts the second boss.

In an embodiment of the present invention, the first boss has a first section and a second section. The first section has the first opening, and passes through the second opening. The second section contacts the substrate, and is restricted in one end of the second opening.

In an embodiment of the present invention, the first housing further has at least one third boss, in which the sidewall of the third boss is connected to the sidewall of the first boss, and one end of the third boss contacts the substrate.

In an embodiment of the present invention, the second housing further has at least one fourth boss, in which the sidewall of the fourth boss is connected to the sidewall of the second boss, and one end of the fourth boss contacts the substrate.

In an embodiment of the present invention, the first housing further has at least one third boss, located outside the first boss, and one end of the third boss contacts the substrate.

In an embodiment of the present invention, the second housing further has at least one fourth boss, located outside the second boss, and one end of the fourth boss contacts the substrate.

In view of the above, according to the fastening structure of the present invention, both the metal sidewall and the sidewall of the fastening component therein do not contact the substrate, such that the heat generated from the substrate may not be directly conducted to the first housing through the metal sidewall with a high thermal conductivity and the sidewall of the fastening component. Therefore, the fastening structure of the present invention can reduce the heat transferred to the first housing, so as to lower the temperature of the first housing, and thus, the user may not feel uncomfortable when contacting or resting on the first housing with the hands, but operate an electronic device comfortably.

In order to make the aforementioned and other features, and advantages of the present invention comprehensible, embodiments accompanied with figures are described in detail below.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic view of a fastening structure in a conventional notebook.

FIG. 2 is a schematic view of a fastening structure according to a first embodiment of the present invention.

FIG. 3 is a schematic view of a fastening structure according to a second embodiment of the present invention.

FIG. 4 is a schematic view of a fastening structure according to a third embodiment of the present invention.

FIG. 5A is a schematic view of a fastening structure according to a fourth embodiment of the present invention.

FIG. 5B is a schematic bottom view of the first housing in FIG. 5A.

FIG. 5C is a schematic top view of the second housing in FIG. 5A.

FIG. 6 is a schematic view of a fastening structure according to a fifth embodiment of the present invention.

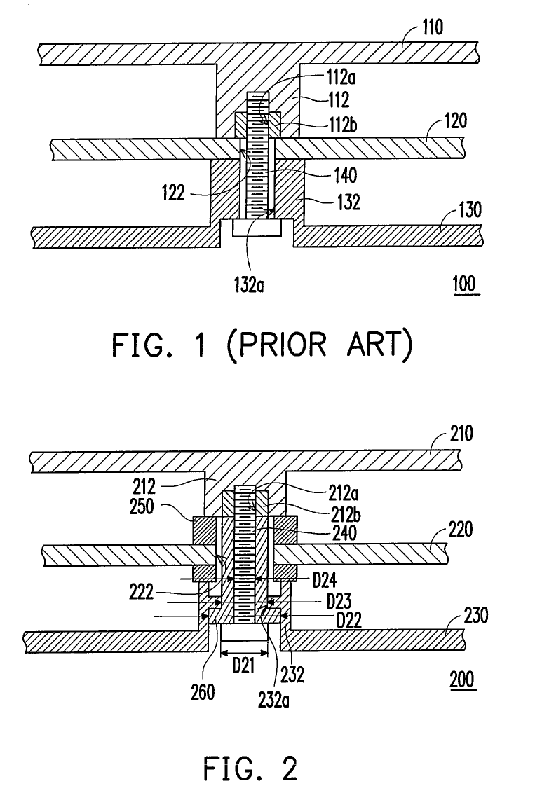

### DESCRIPTION OF EMBODIMENTS

Five embodiments are given below to illustrate the implementing manner of the present invention, but the present invention is not limited thereto. The first, second, and third embodiments are similar in structure, so after the first embodiment is illustrated, the second and third embodiments will be illustrated directed to their differences from the first embodiment, and the details of the similarities will not be described herein again. Furthermore, the fourth and fifth embodiments are similar in structure, so after the fourth embodiment is illustrated, the fifth embodiment will be illustrated directed to its difference from the fourth embodiment, and the details of similarities will not be described herein again.

### The First Embodiment

FIG. 2 is a schematic view of a fastening structure according to a first embodiment of the present invention. Referring to FIG. 2, the fastening structure 200 includes a first housing 210, a substrate 220, a second housing 230, a fastening component 240, a plurality of elastic pads 250, and a sleeve 260. The first housing 210 has a first boss 212 with a first opening 212a, and one sidewall 212b of the first opening 212a is made of metal, for providing the strength for fastening the fastening component 240. The substrate 220 has a second opening 222. The second housing 230 has a second boss 232 with a third opening 232a.

The substrate 220 is located between the first housing 210 and the second housing 230; and the first opening 212a, the second opening 222, and the third opening 232a are coaxial, such that the fastening component 240 passes through the axle center, to restrict the horizontal relative positions for the first housing 210, the substrate 220, and the second housing 230.

The fastening component 240 is, for example, a screw. The sleeve 260 is located on the sidewall of the fastening component 240, and the outer diameter D21 of the head of the fastening component 240 is larger than the inner diameter D24 of the sleeve 260, such that the fastening component 240 and the sleeve 260 are mutually interfered in structure. The sleeve 260 is used to restrict the depth for the fastening component 240 to be fastened in the first housing 210, so as to prevent the fastening component 240 from being fastened too deep to make the first housing 210 be damaged.

One end of the fastening component 240 passes through the third opening 232a and the second opening 222, and is fastened in the first opening 212a. The outer diameter D22 of one end of the sleeve 260 is larger than the bore diameter D23 of the third opening 232a, so as to restrict the relative distance between the second housing 230 and the first housing 210, and to fasten the substrate 220 between the first housing 210 and the second housing 230. The sleeve 260 can also be used to isolate the sidewall of the fastening component 240 from the substrate 220. In this embodiment, the sleeve 260 is mutually snapped with the second housing 230. However, in another embodiment (not shown), the sleeve 260 and the second housing 230 are integrally formed.

It should be noted that, two elastic pads 250 are respectively disposed between the substrate 220 and the first boss 212 and between the substrate 220 and the second boss 232, so as to prevent the metal sidewall 212b from contacting the substrate 220. The thermal conductivity of the elastic pad 250 is smaller than that of the sidewall 212b. Furthermore, in another embodiment (not shown), the elastic pad 250 is disposed depend upon actual demands. For example, the elastic pad 250 is disposed between the first housing 210 and the substrate 220, for insulating the heat generated from the substrate 220.

### The Second Embodiment

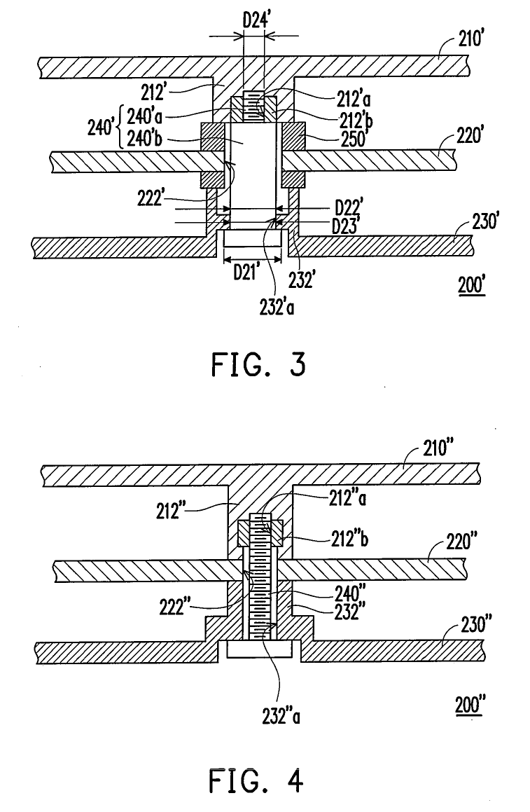

FIG. 3 is a schematic view of a fastening structure according to a second embodiment of the present invention. Referring to FIG. 2 and FIG. 3, the fastening structure 200′ of this embodiment is similar to the fastening structure 200 in the first embodiment, and the major difference there-between is that the fastening component 240 and the sleeve 260 in FIG. 2 are replaced by the fastening component 240′ in FIG. 3. The difference is illustrated below, and the other similarities will not be described herein again. The fastening component 240′ is, for example, a screw, and the outer diameter D21′ of the head is larger than the bore diameter D23′ of the third opening 232′a, such that the head of the fastening component 240′ and the second housing 230′ are mutually interfered in structure, and thus restricting the relative positions between the fastening component 240′ and the second housing 230′.

In addition, the fastening component 240′ has a first section 240′a and a second section 240′b. The second section 240′b may not have a thread, and the outer diameter D24′ of the first section 240′a is smaller than the outer diameter D22′ of the second section 240′b. After one end of the fastening component 240′ passes through the third opening 232′a, the second opening 222′, and the first opening 212′a, the first section 240′a is fastened in the first opening 212′a, and the other end of the fastening component 240′ is restricted in one end of the third opening 232′a, so as to fasten the substrate 220′ between the first housing 210′ and the second housing 230′.

### The Third Embodiment

FIG. 4 is a schematic view of a fastening structure according to a third embodiment of the present invention. Referring to FIG. 2 and FIG. 4, the fastening structure 200″ of this embodiment is similar to the fastening structure 200 in the first embodiment, but the major difference between the two fastening structures is that, the metal sidewall 212b of the first opening 212a in FIG. 2 is isolated from the substrate 220 by the elastic pad 250; while the metal sidewall 212″b of the first opening 212″a in FIG. 4 is embedded into the first boss 212″, without contacting the substrate 220″, and the thermal conductivity of the first boss 212″ is smaller than that of the metal sidewall 212″b. Thus, the heat generated from the substrate 220″ may not be directly transferred from the metal sidewall 212″b with a high thermal conductivity to the first housing 210″.

In addition, in another embodiment (not shown), two elastic pads 250 as in the first embodiment are respectively disposed between the first boss 212″ and the substrate 220″ and between the second boss 232″ and the substrate 220″. Moreover, an elastic pad 250 can be disposed between the first housing 2100″ and the substrate 220″.

### The Fourth Embodiment

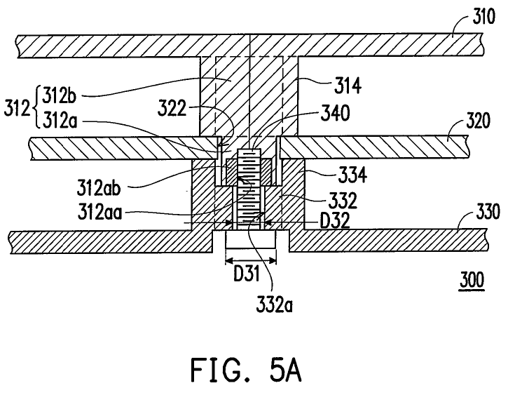

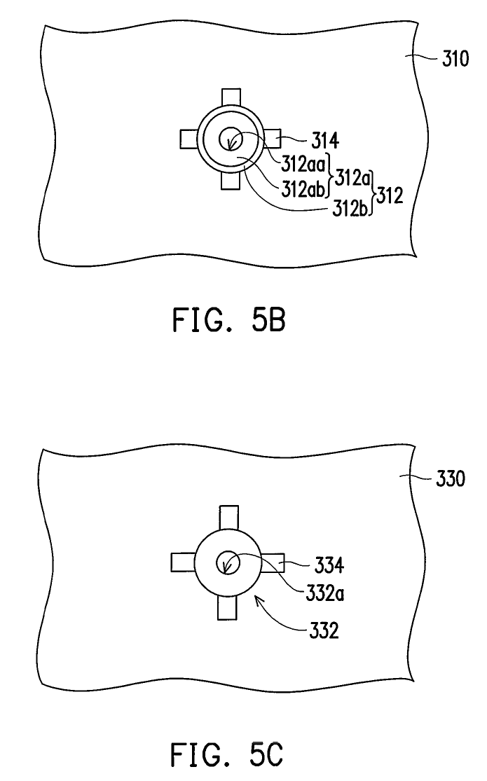

FIG. 5A is a schematic view of a fastening structure according to a fourth embodiment of the present invention. Referring to FIG. 5A, the fastening structure 300 includes a first housing 310, a substrate 320, a second housing 330, and a fastening component 340. The first housing 310 has a first boss 312. The substrate 320 has a second opening 322. The second housing 330 has a second boss 332 with a third opening 332a.

The first boss 312 has a first section 312a and a second section 312b. The first section 312a passes through the second opening 322 and contacts the second boss 332. In addition, the first section 312a has a first opening 312aa, and a sidewall 312ab of the first opening 312aa is made of metal, for providing the strength for fastening the fastening component 340.

FIG. 5B is a schematic bottom view of the first housing in FIG. 5A. Referring to FIG. 5A and FIG. 5B, the first housing 310 further has at least one third boss 314 (four third bosses 314 shown in FIG. 5B), and the sidewall of each third boss 314 is connected to the sidewall of the second section 312b. Moreover, one end of each third boss 314 contacts the substrate 320, so as to restrict the vertical distance between the first housing 310 and the substrate 320.

The substrate 320 is located between the first housing 310 and the second housing 330; and the first opening 312a, the second opening 322, and the third opening 332 are coaxial, such that the fastening component 340 passes through the axle center, to restrict the horizontal relative positions for the first housing 310, the substrate 320, and the second housing 330.

FIG. 5C is a schematic top view of the second housing in FIG. 5A. Referring to FIG. 5A and FIG. 5C, the second housing 330 further has at least one fourth boss 334 (four fourth bosses 334 shown in FIG. 5C), and the sidewall of each fourth boss 334 is connected to the sidewall of the second boss 332. Moreover, one end of each fourth boss 334 contacts the substrate 320, so as to restrict the vertical distance between the second housing 330 and the substrate 320.

The fastening component 340 is, for example, a screw. One end of the fastening component 340 passes through the third opening 332a and is fastened in the first opening 312a, and the other end is restricted in one end of the third opening 332a as the outer diameter D31 of the head is larger than the inner diameter D32 of the third opening 332a, so as to fasten the substrate 320 between the first housing 310 and the second housing 330. Both the metal sidewall 312a and the sidewall of the fastening component 340 do not contact the substrate 320.

### The Fifth Embodiment

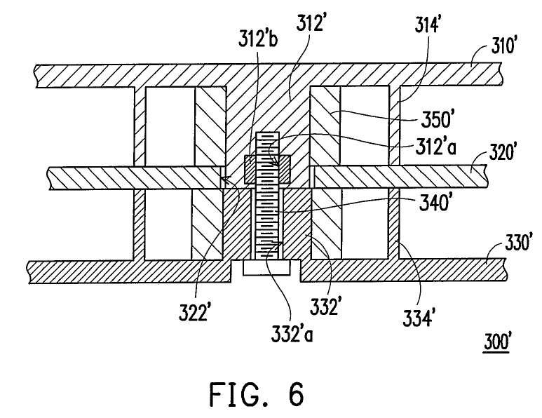

FIG. 6 is a schematic view of a fastening structure according to a fifth embodiment of the present invention. Referring to FIG. 5 and FIG. 6, the fastening structure 300′ of this embodiment is similar to the fastening structure 300 in the fourth embodiment, but the major difference there-between is that, the sidewall of the third boss 314′ is not connected to the sidewall of the second boss 312′, the sidewall of the fourth boss 334′ is not connected to the sidewall of the second boss 332′, and two elastic pads 350′ are respectively disposed between the first housing 310′ and the substrate 320′ and between the substrate 320′ and the second housing 330′. Thus, both the metal sidewall 312′b and the sidewall of the fastening component 340′ do not contact the substrate 320′.

In view of the above, according to the fastening structure of the present invention, both the metal sidewall and the sidewall of the fastening component therein do not contact the substrate, such that the heat generated from the substrate may not be directly conducted to the first housing through the metal sidewall with a high thermal conductivity and the sidewall of the fastening component. Therefore, the fastening structure of the present invention can reduce the heat transferred to the first housing, so as to lower the temperature of the first housing, and thus, the user may not feel uncomfortable when contacting or resting on the first housing with the hands, but operate an electronic device (such as notebook) comfortably.

Though the present invention has been disclosed above by the embodiments, they are not intended to limit the present invention. Anybody skilled in the art can make some modifications and variations without departing from the spirit and scope of the present invention. Therefore, the protecting range of the present invention falls in the appended claims.

What is claimed is:

1. A fastening structure, comprising:
a first housing, having a first boss with a first opening, wherein one sidewall of the first opening is made of metal;
a substrate, having a second opening,
a second housing, having a second boss with a third opening; and
a fastening component, with one end passing through the third opening and fastened in the first opening, and with the other end being restricted in one end of the third opening to fasten the substrate between the first housing and the second housing, wherein both the metal sidewall and a sidewall of the fastening component therein do not contact the substrate.

2. The fastening structure as claimed in claim 1, wherein an outer diameter of the other end of the fastening component is larger than an inner diameter of the third opening.

3. The fastening structure as claimed in claim 1, wherein the fastening component is a screw.

4. The fastening structure as claimed in claim 1, wherein the first opening, the second opening, and the third opening are coaxial.

5. The fastening structure as claimed in claim 1, wherein the end of the fastening component further passes through the second opening and is fastened in the first opening.

6. The fastening structure as claimed in claim 1, further comprising:
an elastic pad, clamped between the first boss and the substrate, and having a thermal conductivity smaller than that of the metal.

7. The fastening structure as claimed in claim 1, further comprising:
an elastic pad, clamped between the second boss and the substrate, and having a thermal conductivity smaller than that of the metal.

8. The fastening structure as claimed in claim 1, further comprising:
an elastic pad, clamped between the first housing and the substrate, and having a thermal conductivity smaller than that of the metal.

9. The fastening structure as claimed in claim 1, further comprising:
an elastic pad, clamped between the second housing and the substrate, and having a thermal conductivity smaller than that of the metal.

10. The fastening structure as claimed in claim 1, further comprising:
a sleeve, located between the sidewall of the fastening component and the second opening of the substrate.

11. The fastening structure as claimed in claim 1, further comprising:
a sleeve, with one end passing through the third opening and the second opening, wherein the end of the fastening component passes through the sleeve and is fastened in the first opening.

12. The fastening structure as claimed in claim 11, wherein the sleeve restricts a depth for the end of the fastening component in the first opening.

13. The fastening structure as claimed in claim 11, wherein an outer diameter of the other end of the sleeve is larger than an inner diameter of the third opening.

14. The fastening structure as claimed in claim 1, wherein the fastening component has a first section and a second section, when the end of the fastening component passes through the third opening and fastens in the first opening, the first section is fastened in the first opening; and the other end of the fastening component is restricted in one end of the third opening, so as to fasten the substrate between the first housing and the second housing.

15. The fastening structure as claimed in claim 14, wherein an outer diameter of the first section is smaller than that of the second section.

16. The fastening structure as claimed in claim 1, wherein one end of the first boss contacts the substrate.

17. The fastening structure as claimed in claim 1, wherein one end of the first boss passes through the second opening, and contacts the second boss.

18. The fastening structure as claimed in claim 1, wherein the first boss has a first section and a second section, the first section has the first opening, and passes through the second opening, and the second section contacts the substrate and is restricted in one end of the second opening.

19. The fastening structure as claimed in claim 1, wherein the first housing further has at least one third boss, a sidewall of the third boss is connected to the sidewall of the first boss, and one end of the third boss contacts the substrate.

20. The fastening structure as claimed in claim 19, wherein the second housing further has at least one fourth boss, a sidewall of the fourth boss is connected to the sidewall of the second boss, and one end of the fourth boss contacts the substrate.

21. The fastening structure as claimed in claim 1, wherein the first housing further has at least one third boss, located outside the first boss, and one end of the third boss contacts the substrate.

22. The fastening structure as claimed in claim 21, wherein the second housing further has at least one fourth boss, located outside the second boss, and one end of the fourth boss contacts the substrate.
